(19) United States
(12) Patent Application Publication
(10) Pub. No.: US 2023/0095690 A1
(43) Pub. Date: Mar. 30, 2023

(54) MIXED SPICE AND MASKING COMPOSITION THAT CONTAINS SAME

(71) Applicant: HOUSE FOODS CORPORATION, Osaka (JP)

(72) Inventors: Chikako ISHIKAWA, Higashi-Osaka-shi, Osaka (JP); Keiko MATSUBARA, Higashi-Osaka-shi, Osaka (JP)

(21) Appl. No.: 17/800,771

(22) PCT Filed: Feb. 25, 2021
(86) PCT No.: PCT/JP2021/007007

§ 371 Date: Aug. 18, 2022

(30) Foreign Application Priority Data
Feb. 25, 2020 (JP) 2020-029136
Aug. 6, 2020 (JP) 2020-134001

(51) Int. Cl. A23L 27/14; A23L 13/40

(52) U.S. Cl. CPC A23L 27/14; A23L 13/428

(57) ABSTRACT

The purpose of the present invention is to provide: a spice that is useful for cooking bento lunches, side dishes, etc., that have a long shelf life; and a mixed spice that contains the aforementioned spice. According to the present invention, at least one spice selected from the group consisting of coriander seeds, coriander leaves, thyme, cloves, allspice, rosemary, lemongrass, Italian spice, and oregano is used, thereby making it possible to reduce unique unpleasant odors derived from meats and other food products, the unpleasant odors being produced in association with the elapse of time after cooking with heat.

### TECHNICAL FIELD

The present invention relates to a mixed spice and a masking composition containing the same, and particularly relates to a mixed spice containing spices effective in reducing an unfavorable flavor, a masking composition containing the same or a food or drink, a method for producing the mixed spice, and a composition for reducing an unpleasant odor of a cooked meat product.

### BACKGROUND ART

Coriander seeds are dried coriander fruits and have a citrus-like refreshing, gorgeous and characteristic scent. The citrus-like scent of coriander seeds is due to aromatic components such as linalool, limonene, geraniol, and nerol, and it is evaluated that the higher the content of these, the stronger the scent and the better the quality.

Coriander seeds can be added to a dish as a spice, either as is or in the form of a ground product, to improve the aroma of the whole dish and give it a unique taste. In particular, Coriander seed is also known as one of the spices mixed with curry powder, and is an important constituent component that determines the aroma and flavor of dishes such as curly sauce.

On the other hand, roasted coriander seeds prepared by roasting unground coriander seeds are also known. Patent Literature 1 states that coriander seeds roasted under the specific conditions have both a fresh scent and a roasted scent, and can enhance the richness of food or drink and mask meat odor. Further, Patent Literatures 2 to 4 state that a mixed spice containing various spices has a masking effect on a specific unpleasant odor. However, Patent Literatures 1 to 4 do not describe masking of a unique unpleasant odor derived from meat, which occurs over time after cooking.

### CITATION LIST

### Patent Literatures

Patent Literature 1: Japanese Patent Publication No. 2019-208368

Patent Literature 2: Japanese Patent Publication No. 2018-57309

Patent Literature 3: Japanese Patent Publication No. 2011-4640

Patent Literature 4: international Publication No. WO2006/062174

### SUMMARY OF INVENTION

### Problems to be Solved by the Invention

In order to deal with the problem of food that is still edible but discarded, so-called food loss, products such as long-lasting bento or prepared foods are required, while there is also a demand for products that do not use food additives due to the growing health consciousness in recent years. An object of the present invention is to provide a spice useful for cooking a bento or a prepared food that lasts for a long time and a mixed spice containing the same.

### Means for Solving the Problems

The present inventors have made earnest studies to achieve the above object, and have found as a result that certain spices have the effect of reducing the unique unpleasant odor derived from foods such as meat, which occurs over time after cooking. Thus, the present invention has been completed. Specifically, the present invention provides the following mixed spices and masking compositions or food or drink containing the same, methods for producing mixed spices, and compositions for reducing the unpleasant odor of a cooked meat product.

[1] A mixed spice comprising: at least one spice selected from the group consisting of coriander seeds, coriander leaves, thyme, cloves, allspice, rosemary, lemongrass, Italian parsley, and oregano; and a roasted coriander seed.

[2] The mixed spice according to [1], wherein the roasted coriander seed has a fresh scent and a roasted scent.

[3] A masking composition comprising: the mixed spice according to [1] or [2],

[4] A food or drink comprising: the mixed spice according to [1] or [2].

[5] A method for producing a mixed spice, comprising: mixing at least one spice selected from the group consisting of coriander seeds, coriander leaves, thyme, cloves, allspice, rosemary, lemongrass, Italian parsley, and oregano with a roasted coriander seed.

[6] The production method according to [5], wherein the mixed spice is for masking.

[7] A composition comprising: at least one spice selected from the group consisting of coriander seeds, coriander leaves, thyme, cloves, allspice, rosemary, lemongrass, Italian parsley, and oregano, for reducing an unpleasant odor of food,

[8] The composition according to [7], wherein the food is a cooked meat product.

### Advantageous Effects of Invention

According to the present invention, by using at least one spice selected from the group consisting of coriander seeds, coriander leaves, thyme, cloves, allspice, rosemary, lemongrass, Italian parsley, and oregano, it is possible to reduce the unique unpleasant odor derived from foods such as meat, which occurs over time after cooking. Therefore, when these spices are combined with spices with other effects, such as roasted coriander seeds for masking meat odor, it is possible to comprehensively improve the flavor of foods such as a cooked meat product, and it is possible to produce products such as bento or prepared foods that last for a long time without using food additives.

### DESCRIPTION OF EMBODIMENTS

Hereinafter, the present invention is described in more detail.

The “mixed spice” described in the present specification refers to a seasoning that contains a combination of two or more kinds of spices and adjusts the aroma, spiciness, color, and the like of food or drink. The mixed spice of the present invention contains at least one spice selected from the group consisting of coriander seeds, coriander leaves, thyme, cloves, allspice, rosemary, lemongrass, Italian parsley, and oregano. For example, when meat is cooked, a unique unpleasant (such as oxidation of fats and oils in the meat) odor occurs over time, but the above spice has an effect of reducing such a unique unpleasant odor (such as an oxidative odor) derived from meat. Without wishing to be bound by theory, but the spice can reduce the unpleasant odor by, for example, suppressing the occurrence of the unpleasant odor or masking the unpleasant odor.

The amount of the spice used is not particularly; limited as long as the unpleasant odor can be reduced, but for example, each of the spices may be used in an amount of about 0.0005% by mass or more, preferably in an amount of about 0.001% by mass to about 0.2% by mass, and more preferably about 0.002% by mass to about 0,1% by mass, based on the mass of the meat. When the spice is used in an amount in such a range, the effect of reducing the unpleasant odor can be better exerted within a range in which the flavor of the spice itself is not felt or slightly felt. That is, since the effect of reducing the unpleasant odor can be exerted even with a small amount of use, if two or more kinds of the spices are used in combination, the amount of each spice used can be suppressed, while the effect of reducing the unpleasant odor can be enhanced. Of course, in order to impart the flavor of the spices to a cooked product, the use of spices in amounts exceeding those necessary to reduce the unpleasant odor is not precluded. Note that the meat is not particularly limited as long as it is edible meat such as livestock meat, and for example, it may be at least one selected from the group consisting of poultry such as chicken, beef, pork, horse meat, mutton, goat meat, venison, and boar meat. Further, the type of unpleasant odor reduced by the spice is not limited to the unpleasant odor of a cooked meat product, and for example, it may be an unpleasant odor derived from foods including seafood such as man clam, eggs, cow's milk, vegetables such as shimeji mushroom and carrots, or soy protein. The amount of the spice used for these foods is not particularly limited, and may be used in the same amount as described for meat.

The mixed spice of the present invention may contain one or more additional spices in addition to the spice. As the additional spices, those usually used in the art can be appropriately employed according to the purpose, and for example, the additional spices may be a spice having a meat odor masking action such as roasted coriander seeds. When the roasted coriander seed is blended in the mixed spice, the roasted scent and the like of the spice can also make the flavor of the spice itself, which has the effect of reducing the unpleasant odor mentioned above, less noticeable, thus making the flavor of the mixed spice as a whole less noticeable.

The amount of the additional spices used is not particularly limited as long as it meets the purpose of adding the spices, but for example, the additional spices may be used in an amount of about 0.0005% by mass or more, preferably in an amount of about 0.001% by mass to about 0.2% by mass, and more preferably about 0.01% by mass to about 0.1% by mass, based on the mass of the target food. Note that the meat odor refers to the odor of meat itself, and is distinguished from the unique unpleasant odor derived from meat, which occurs over time after cooking.

As used in the present specification, the term “roasted coriander seed” refers to dried coriander fruits that can be used as spices and is heat-dried without using oil or water, and after such roasting treatment, it may be ground by a conventional method and used in the form of powder. The raw material of the roasted coriander seed is not particularly limited, but unground coriander seed is preferable. Note that “unground” means that the grounding treatment is not performed, and “unground coriander seeds” also include coriander seeds with some of its grains reduced to about half to one-eighth. In some embodiments, the roasted coriander seed may contain a citrus-like scent component (fresh scent) originally possessed by the coriander seed before roasting and an aroma component (such as roasted scent and increased fresh scent) generated during roasting. The fresh scent is a citrus-like scent component originally possessed by coriander seeds, and is at least one selected from the group consisting of β-linalool, limonene, linalyl acetate, citronellyl acetate, nerol, geraniol, and geraniol acetate. The roasted scent is a fragrant scent component produced by subjecting coriander seeds to a roasting treatment, and is at least one selected from the group consisting of 2-methylpyrazine, 2-ethylpyrazine, 2,3-dimethylpyrazine, 2,5-dimethylpyrazine, 2,6-dimethylpyrazine, 2-ethyl-5-methylpyrazine, 2-ethyl-6-methylpyrazine, 3-ethyl-2,5-dimethylpyrazine, trimethylpyrazine, furfural, furfuryl acetate, acetvlfuran, pyrrole, furfurylpyrrole, and 2-acetylpyrrole.

In some embodiments, the amount of the fresh scent and the roasted scent in the roasted coriander seed may satisfy a particular relationship. Specifically, the roasted coriander seed is ground to a particle diameter of 1 mm or less (a particle size that passes through a JIS test sieve having an opening of 1 mm), and decane is added as an internal standard substance at a ratio of 14.7 mass ppm based on the mass of the ground roasted coriander seed, followed by analysis by gas chromatograph mass spectrometry (GC/MS method). In this case, the total peak area [A] derived from the fresh scent and the total peak area [B] derived from the roasted scent satisfy the following condition (1):

0.01≤[B]/[A]≤0.2 (1)

and preferably satisfy the following condition (1′):

0.02≤[B]/[A]<0.1. (1′)

In addition to this, the peak area [D] derived from the decan and the [B] satisfy the following condition (2):

[B]/[D]≥0.1 (2)

and preferably satisfy the following condition (2′):

[B]/[D]≥0.3. (2′)

When the coriander seeds are sufficiently roasted and the aroma components generated during roasting are retained in the roasted coriander seeds, each condition is satisfied. The peak area of the aromatic components in the roasted coriander seeds is a value obtained by gas chromatograph mass spectrometry (GMS spectrometry) using a solid phase micro extraction (SPME method). For detailed conditions, see the section of the Examples in Patent Literature 1 described above.

In some embodiments, the roasted coriander seed may further contain a burnt scent. The burnt scent is at least one selected from the group consisting of phenol, o-cresol, m-cresol, p-cresol, guaiacol, and 4-ethylguaiacol. Since the burnt scent is generated when the coriander seeds are burnt in a roasting treatment, the amount thereof is advantageously small, and when mass spectrometry is performed as described above, the total peak area [C] derived from the burnt scent can satisfy the following condition (3):

[C]<([A]+[B])×0.01. (3)

In a further embodiment, the amount of fresh scent in the roasted coriander seeds is sufficiently retained or rather increased as compared to the coriander seeds before roasted. Therefore, when the coriander seeds before roasted are subjected to mass spectrometry in the same manner as the roasted coriander seeds, the total peak area [A′] derived from the fresh scent and the [A] may satisfy the following conditions:

[A]≥[A′]×0.4. (4)

The mixed spice of the present invention may further contain any seasoning and/or any additive or the like commonly used in the art, as long as the object of the present invention is not impaired.

In another aspect, the present invention also relates to a masking composition containing the mixed spice. As used in the present specification, the term “masking” refers to an application used to reduce an unpleasant odor. In some embodiments, the masking composition is used to reduce the unique unpleasant odor derived from foods such as meat, which occurs over time after cooking. The masking composition of the present invention may further contain any seasoning and/or any additive or the like commonly used in the art, as long as the object of the present invention is not impaired.

In yet another embodiment, the present invention also relates to food or drink containing the mixed spice. The mixed spice is effective in reducing the unique unpleasant odor derived from foods such as meat, which occurs over time after cooking, and thus can maintain good flavor, especially in food or drink, including cooked meat products. In some embodiments, the food or drink of the invention may further include heated meat (that is, cooked meat products). Specific examples of the food or drink include, but are not limited to, lento and prepared foods such as curry, oyakodon, pork bowl, yakitori, salad with chicken, and meat sauce spaghetti. The food or drink of the present invention may further contain any seasoning, any food ingredient, and/or any additive, which are commonly used in the art, as long as the object of the present invention is not impaired.

In yet another embodiment, the present invention also relates to a method for producing a mixed spice, including mixing at least one spice selected from the group consisting of coriander seeds, coriander leaves, thyme, cloves, allspice, rosemary, lemongrass, Italian parsley, and oregano with a roasted coriander seed.

In some embodiments, the production method of the present invention may further include preparing the roasted coriander seed, and the preparing may include heat-treating the unground coriander seed at a product temperature of 170° C. or higher, preferably about 170° C. to about 230° C. The time of the heat-treating can be appropriately adjusted so that the desired roasted scent is imparted, and may be, for example, about 4 minutes to about 20 minutes, preferably about 5 minutes to about 18 minutes. The preparing the roasted coriander seed may further include ground-treating the heat-treated unground coriander seed. The ground-treating can be appropriately performed by using means usually used in the art.

The production method of the present invention may further include steps that can be usually employed in the production of mixed spices. In addition, the production method of the present invention may further include, for example, adding any seasoning and/or any additive or the like commonly used in the art, as long as the object of the present invention is not impaired.

In yet another embodiment, the present invention also relates to a composition for reducing the unpleasant odor of food, and the composition contains at least one spice selected from the group consisting of coriander seeds, coriander leaves, thyme, cloves, allspice, rosemary, lemongrass, Italian parsley, and oregano. The food is not particularly limited, and may be, for example, a cooked meat product, seafood such as asari clam, eggs, cow's milk, vegetables such as shimeji mushroom and carrots, or soy protein. In some embodiments, the composition for reducing the unpleasant odor of the food of the present invention further contains additional spices such as roasted coriander seeds. Further, the composition for reducing the unpleasant odor of the food of the present invention may further contain any seasoning and/or any additive or the like commonly used in the art, as long as the object of the present invention is not impaired.

Hereinafter, the present invention is specifically described with reference to Examples, but the scope of the present invention is not limited to these Examples.

### EXAMPLES

### Test Example 1

Brazilian chicken thighs were cut into bite-sized pieces (5 to 10 g). 100 g of the meat was sprinkled with the additives presented in Table 1 below and left in the refrigerator for about 1 hour. The meat taken out of the refrigerator was placed on a heat-resistant dish, wrapped, and heated in a 600 W microwave oven for 2 Minutes. Note that the roasted coriander seed is prepared by roasting treatment according to Example 1 of Patent Literature 1 (Japanese Patent Publication No. 2019-208368) and ground by a conventional method into a powder.

After cooling the heated meat in the refrigerator and returning it to room temperature, the flavors of the additives themselves used and the meat odors of the cooked chicken thighs were evaluated by five panelists according to the following criteria.

(Flavor of the Additive Itself)

◯ Not felt

Δ Felt a little

× Felt

(Meat Odor)

⊚ Not felt (Comparative Example 3)

◯ Not felt much

Δ Felt

× Felt strongly (Comparative Example 1)

In addition, the same samples were stored in a refrigerator for four days, and the unpleasant odor generated from the cooked chicken thighs was evaluated by five panelists according to the following criteria.

(Unpleasant Odor Derived from Cooked Products)

⊚ Not felt (pre-storage condition)

◯ Not felt much

Δ Felt

× Felt strongly (Comparative Example 1)
Table 1 presents the results of each test.

TABLE 1
Types of additives and test results

| | | | Amount Added | Flavor of | | Unpleasant Odor Derived |
|---|---|---|---|---|---|---|
| | | Additive | [g/Meat 100 g] | Additive Itself | Meat Odor | from Cooked Product |
| Comparative | 1 | Nutmeg | 0.02 | X | X | X |
| Example | 2 | Japanese Rice Wine | 2 | X | Δ | X |
| | 3 | Roasted Coriander Seed | 0.02 | ◯ | ⊚ | Δ |
| Example | 1 | Coriander Seed | 0.02 | Δ | Δ | ⊚ |
| | 2 | Coriander Leaf | 0.02 | Δ | Δ | ◯ |
| | 3 | Thyme | 0.02 | Δ | Δ | ⊚ |
| | 4 | Clove | 0.02 | Δ | Δ | ⊚ |
| | 5 | Allspice | 0.02 | Δ | ◯ | ⊚ |
| | 6 | Rosemary | 0.02 | Δ | Δ | ⊚ |
| | 7 | Lemongrass | 0.02 | Δ | Δ | ◯ |
| | 8 | Italian Parsley | 0.02 | Δ | ◯ | ◯ |
| | 9 | Oregano | 0.02 | Δ | ◯ | ◯ |
| | 10 | Thyme + Clove + | 0.1* ¹ | ◯ | ⊚ | ⊚ |
| | | Allspice + Roasted | | | | |
| | | Coriander Seed | | | | |
| | 11 | Rosemary + Lemongrass + | 0.1* ² | ◯ | ⊚ | ⊚ |
| | | Oregano + Roasted | | | | |
| | | Coriander Seed | | | | |

* ¹ Thyme 0.02 g + clove 0.02 g + allspice 0.02 g + roasted coriander seed 0.04 g
* ² Rosemary 0.02. g + lemongrass 0.02 g + oregano 0.02 g + roasted coriander seed 0.04 g

Even nutmeg, which is generally used to remove the odor of meat, when it was used in an amount of 0.02 g per 100 g of chicken thigh, the flavor of itself was felt, but the effect of masking the meat odor and the effect of reducing the unpleasant odor derived from the cooked products were insufficient (Comparative Example 1). In addition, the use of general Japanese rice wine had some effect on reducing the odor of meat, but it was not sufficient. In the case of Japanese rice wine, in addition to feeling the scent of sake, it had no effect on the unpleasant odor derived from cooked products (Comparative Example 2). The roasted coriander seeds, even when added in an amount that did not feel the flavors of themselves, satisfactorily reduced the odor of meat, but had almost no effect on the unpleasant odor derived from cooked products (Comparative Example 3).

On the other hand, when coriander seeds, coriander leaves, thyme, cloves, allspice, rosemary, lemgrass, Italian parsley, or oregano was used, the unpleasant odor derived from the cooked products could be sufficiently reduced (Examples 1 to 9). The mixed spice containing thyme, cloves, and allspice as well as roasted coriander seeds, or rosemary, lemongrass, and oregano as well as roasted coriander seeds was able to significantly reduce the unpleasant odor derived from the cooked products thanks to the combination of the actions of roasted coriander seeds and each spice, even though the flavor of the blended spice itself was not felt (Examples 10 and 11).

### Test Example 2

A gas chromatograph mass spectrometer (GC/MS) was used to analyze the amount of hexanal in the chicken thighs before the addition of the additives of Test Example 1 and the amount of hexanal in the chicken thighs added with the mixed spice of Example 10 or the chicken thighs stored in a refrigerator for 4 days without additives. As a result, it was found that when the mixed spice of Example 10 was added, the amount of hexanal, which normally increases during storage, was suppressed.

### Test Example 3

Brazilian chicken thighs were cut into bite-sized pieces (5 to 10 g), and 100 g of the meat was placed on a heat-resistant dish, wrapped, and heated in a 600 W microwave oven for 2 minutes. This was stored in a refrigerator for 4 days, and then was sprinkled with 0.1 g of the mixed spice of Example 10 and left in the refrigerator for another 1 hour.

Then, when the unpleasant odor generated from the cooked chicken thighs was evaluated by the same method as in Test Example 1, it was found that the unpleasant odor was greatly reduced to a level that was not felt after the addition of the mixed spice.

### Test Example 4

Equal amounts of coriander seeds, thyme, cloves, and allspice were mixed to prepare the mixed spice of Example 12, and equal amounts of coriander seeds, thyme, cloves, allspice, and roasted coriander seeds were mixed to prepare the mixed spice of Example 13. As a reference example, roasted coriander seeds were prepared.

Various foods were treated as follows with the additive of either the mixed spice of Example 12 or 13 or the spice of Reference Example.

### (1) Asari Clam

Canned boiled asari clam was opened in a colander and the water was drained. The boiled asari clam was sprinkled with the above additives and stored in a refrigerator for 2 days.

### (2) Egg

Eggs were boiled and shelled. The boiled eggs were sprinkled with the above additives and stored in a refrigerator for 2 days.

### (3) Shimeji Mushroom

The bed of shimeji mushrooms was dropped, and they were loosened into small pieces and sprinkled with the above additives. 100 g of shimeji mushrooms were heated in a 600 W microwave oven for 2 minutes and then stored in a refrigerator for 2 days.

### (4) Carrots

Carrots were peeled, cut into thin rectangles, and sprinkled with the above additives. These were stored in the refrigerator for 2 days.

### (5) Cow's Milk

Cow's milk waves mixed with the above additives and stored in a refrigerator for 2 days.

### (6) Soy Protein

Water and commercially available dried soy protein were put in a pan, the above additives were added, and the mixture was cooked. After boiling for 3 to 5 minutes, the heat was turned off and the mixture was stored in a refrigerator for 2 days.

In the same manner as in Test Example 1, the flavors of the additives themselves and the unpleasant odor of each were evaluated according to the following criteria. Tables 2 and 3 present the results.

(Flavor of the Additive Itself)

◯ Not felt

Δ Felt a little

× Felt

(Unpleasant odor of target food)

⊚ Not felt (pre-storage condition)

◯ Not felt much

Δ Felt

× Felt strongly (without additives)

TABLE 2
Amount added (% by mass) to the mass of target food and the flavor of the additive itself

| | Asari Clam | Egg | Shimeji Mushroom | Carrot | Cow's Milk | Soy Protein |
|---|---|---|---|---|---|---|
| Example 12 | 0.04 | 0.04 | 0.04 | 0.04 | 0.01 | 0.04 |
| | ◯ | ◯ | ◯ | ◯ | ◯ | ◯ |
| Example 13 | 0.06 | 0.06 | 0.06 | 0.06 | 0.015 | 0.06 |
| | ◯ | ◯ | ◯ | ◯ | ◯ | ◯ |
| Reference | 0.02 | 0.02 | 0.02 | 0.02 | 0.005 | 0.02 |
| Example | ◯ | ◯ | ◯ | ◯ | ◯ | ◯ |

TABLE 3
Unpleasant odor of target food

| | Asari Clam | Egg | Shimeji Mushroom | Carrot | Cow's Milk | Soy Protein |
|---|---|---|---|---|---|---|
| Example 12 | ◯ | ◯ | ◯ | ◯ | ◯ | ◯ |
| Example 13 | ⊚ | ⊚ | ⊚ | ⊚ | ⊚ | ⊚ |
| Reference | Δ | Δ | Δ | ◯ | Δ | ◯ |
| Example | | | | | | |

The mixed spices of Examples 12 and 13 were able to reduce unpleasant odors derived from various foods even when added in an amount that did not feel the flavors of themselves. In particular, the mixed spice of Example 13 had a less noticeable flavor than the mixed spice of Example 12, but the effect of reducing the unpleasant odor was great. Although the spice of Reference Example was confirmed to have a reducing effect on certain unpleasant odors, the reducing effect was weak on some unpleasant odors.

As above, it has been found that by using at least one spice selected from the group consisting of coriander seeds, coriander leaves, thyme, cloves, allspice, rosemary, lemongrass, Italian parsley, and oregano, it is possible to reduce the unique unpleasant odor derived from foods such as meat, which occurs over time after cooking. Therefore, when these spices are combined with spices with other effects, such as roasted coriander seeds for masking meat odor, it is possible to comprehensively improve the flavor of foods such as a cooked meat product, and it is possible to produce products such as bento or prepared foods that last for a long time without using food additives.

1. A mixed spice comprising: at least one spice selected from the group consisting of coriander seeds, coriander leaves, thyme, cloves, allspice, rosemary, lemongrass, Italian parsley, and oregano; and a roasted coriander seed.

2. The mixed spice according to claim 1, wherein the roasted coriander seed has a fresh scent and a roasted scent.

3. A masking composition comprising: the mixed spice according to claim 1.

4. A food or drink comprising: the mixed spice according to claim 1.

5. A method for producing a mixed spice, comprising: mixing at least one spice selected from the group consisting of coriander seeds, coriander leaves, thyme, cloves, allspice, rosemary, lemongrass, Italian parsley, and oregano with a roasted coriander seed.

6. The production method according to claim 5, wherein the mixed spice is for masking.

7. A method for reducing an unpleasant odor of food, comprising applying to a food a composition comprising: at least one spice selected from the group consisting of coriander seeds, coriander leaves, thyme, cloves, allspice, rosemary, lemongrass, Italian parsley, and oregano.

8. The method according to claim 7, wherein the food is a cooked meat product.
